(19) United States
(12) Patent Application Publication
(10) Pub. No.: US 2013/0255835 A1
(43) Pub. Date: Oct. 3, 2013

(54) AUTOMATIC PENCIL-FEEDING DEVICE FOR PENCIL SHARPENER

(71) Applicant: Xinfu Wang, Fujian (CN)

(72) Inventor: Xinfu Wang, Fujian (CN)

(73) Assignee: FUJIAN SOUNDY ENTERPRISE CO., LTD., Fuzhou City, Fujian (CN)

(21) Appl. No.: 13/991,895

(22) PCT Filed: Dec. 7, 2011
(86) PCT No.: PCT/CN2011/083626

§ 371 Date: Jun. 5, 2013

(30) Foreign Application Priority Data
Dec. 7, 2010 (CN) 201020647480.8

(51) Int. Cl. B43L 23/00

(52) U.S. Cl. CPC B43L 23/002
USPC 144/28.2

(57) ABSTRACT

An automatic pencil-feeding device for a pencil sharpener, comprising a bracket (1) and a rotary disc (3), rotating shafts (5) respectively located at two pairs of clamping wheel bearing seats (11) of the bracket (1), rotating wheels (51) and friction wheels (52) for clamping pencils successively nested on the rotating shafts (5), and the two friction wheels (52) located at the ends of the two rotating shafts which are remote from each other. The rotary disc (3) is arranged in the middle of the two pairs of clamping wheel bearing seats (11), in the middle of the bracket (1) and the rotary disc (3) is provided a through-hole (31) enabling a pencil to be passed through. In a sinking shaft seat (12) located at the side of the bracket (1) facing towards the rotary disc (3) there is provided a driving plate (2), in the centre of the driving plate (2) there is provided a connecting hole (21) which enables a hob-seat (4) of a hollow pencil holder (41) to be interposed and guided to the end of a tapered-hole; on the periphery of the end face of the driving plate (2) there are provided two or more grooves (22), and each of the grooves (22) has a sloping bottom; there is a raised corresponding shift lever (32) on the end face of the rotary disc (3) on the side adjacent to the driving plate (2), and the shift lever (32) is inserted into the grooves (22) to form a linkage. When a driving force for rotation is transmitted via the driving plate (2), the sloping bottom on each of the grooves (22) thereof has contact with the rotary disc (3) with different strengths when rotating in a forward and in a reverse direction, such that the friction forces produced between the rotary disc (3) and the friction wheels (52) are different, causing two different manual sensations of tightness and relaxation respectively when the pencil is fed and released therefrom.

### BACKGROUND OF THE INVENTION

The utility model belongs to the stationery filed, and in particular relates to the improvement of an automatic feeding device for a suction pencil sharpener, which has the advantages of being reliable and using forceful feeding, being easy to use and having flexible discharge.

It is known that the holding and feeding devices of pencil sharpeners are all set at the outside of the pencil sharpener housings, each is set on the housings through two elastic guide rods and feeding the pencil by means of the spring force of the elastic guide rods. The operation is complicated. Therefore, the technicians in this field made some improvements before, for example, the Patent Publication No. CN2797078Y discloses an automatic pencil feeding and discharging device for a pencil sharpener. The device comprises a support and a turntable fixed in the housing of the pencil sharpener. The support extends towards the same side to form two pairs of wheel-holding bearing blocks. Two rotating shafts with pencil-holding rotating wheels capable of moving axially are respectively located at the two pairs of wheel-holding bearing blocks. The turntable is installed in the middle between the two wheel-holding bearing blocks and clamped between the rotating shafts and the support. The turntable is centrally formed with a throughhole coaxial with the tapered guide-hole for a hollow pencil holder on a hobbing head. The hobbing head drives the turntable to rotate, wherein the two friction wheels capable of being touched by the turntable surface are respectively erected at the far ends of both of the rotating shafts and sleeved on running wheels. A key groove is formed in the shaft hole of each running wheel. Each rotating shaft is provided with a convex key corresponding to the key groove. The end face of each of the running wheels can touch the end faces of the wheel-holding rotating wheels, driving the wheel-holding rotating wheels to rotate and feed the pencil holder through the friction force. In this art, the pressure of the turntable applied to the surfaces of the friction wheels is constant no matter whether it is in the feeding or discharging state, so the working state cannot be judged through feel.

### BRIEF SUMMARY OF THE INVENTION

The objective of the utility model is to provide an automatic pencil feeding device for a pencil sharpener, which automatically feeds or discharges a pencil along with the rotation of the hobbing and applies different friction forces in the feeding and discharging processes.

The technical scheme of the utility model is realized in this way: An automatic pencil feeding device for a pencil sharpener comprises a support and a turntable fixed in the housing of the pencil sharpener. The support extends towards the same side to form two pairs of wheel-holding bearing blocks. Rotating shafts capable of moving axially are respectively located on the two pairs of the wheel-holding bearing blocks. A pencil-holding rotating wheel and a friction wheel are sleeved on each rotating shaft in turn. The two friction wheels are located on the far ends of the two rotating shafts. The turntable is located in the middle between the two wheel-holding bearing blocks and has surfaces capable of touching the two friction wheels. The support and the turntable are centrally formed with a throughhole through which the pencil holder passes. The automatic pencil feeding device for a pencil sharpener is characterized in the following features. One side of the support facing towards the turntable is provided with a sinking axle seat. A drive plate is placed in the sinking axle seat. The drive plate is centrally formed with a connecting hole in which the tapered-hole end of a hollow pencil holder guide of a hobbing head is inserted. The end face of the drive plate is circumferentially formed with more than two grooves having sloping bottoms. The end face of the turntable adjacent to the drive plate is convexly provided with forks corresponding in number to the grooves of the drive plate. The forks are inserted into the grooves, forming a linkage between the drive plate and the turntable. The drive plate transmits the rotation force, and the different friction forces generated between the turntable and the friction wheels are different because of different forces applied to the turntable when the inclined bottoms of the grooves rotate clockwise and anticlockwise, thereby generating two different pressures of being tight and loose when the pencil is fed.

A spring is pivotally disposed between the turntable and the sinking axle seat. The contact between the turntable and the friction wheels is always kept through the spring force, thus preventing slipping.

The end face of the turntable adjacent to the sinking axle seat is provided with a reed pressed against the end face of the sinking axle seat, achieving the effect described above.

The reed is integrally molded with the drive plate, having an arced end without influences on the clockwise and anticlockwise rotations of the turntable.

The surface of the turntable is provided with radial friction patterns, and the surfaces of the friction wheels are provided with fine, transverse patterns, thus effectively preventing slipping.

Each friction wheel is made from the rubber material through molding and sleeved on a running wheel of which the axle hole is formed with a pair of key grooves. The rotating shaft is convexly provided with two convex keys. The running wheel is movably located on the rotating shaft through the fit between the convex keys and the key grooves, thus ensuring friction transmission with the turntable and smoothly realizing separation from and reunion with the rotating shaft.

The utility model has a more rational structure. Except for the remaining features of separation and reunion between the friction wheels and the rotating shaft, the automatic pencil feeding device generates two different feels about the clockwise and anticlockwise rotation when the pencil is sharpened. During sharpening, the turntable is more tightly pressed against the friction wheels, so the power transmission is more reliable and the pencil feeding is prevented from slipping. When the pencil is discharged, the turntable slightly contacts the friction wheels, so the discharge operation is more flexible, and it is easy to take out the sharpened pencil holder.

### BRIEF DESCRIPTION OF THE DRAWINGS

The utility model is described in further details with references to the attached drawings.

FIG. 1 is the relation graph of the automatic pencil feeding device for pencil sharpener and the hobbing head.

FIG. 2 is a three-dimensional view of the automatic pencil feeding device of the pencil sharpener.

FIG. 3 is an exploded view of the automatic pencil feeding device of the pencil sharpener.

FIG. 4 is a schematic view of the drive plate and the turntable.

FIG. 5 is a schematic view of the pencil discharging state.

FIG. 6 is a schematic view of the pencil feeding state.

Wherein

TABLE 1

| | | |
|---|---|---|
| 1-Support | 11-Wheel-holding | 12- Sinking axle seat |
| | bearing block | |
| 2-Drive plate | 21-Connecting hole | 22-Groove |
| 23-Sloping bottom | 24- Reed | 240-Arced end |
| 3-Turntable | 31-Through hole | 32-Fork |
| 33-Friction patterns | 4-Hobbing head | 41-Hollow pencil holder |
| 5-Rotating shaft | 51-Pencil-holding | 52-Friction wheel |
| | rotating wheel | |
| 520-Fine, transverse | 53-Running wheel | 530-Axle hole |
| patterns | | |
| 531-Key groove | 54-Convex key | 6- Pencil holder |

### DETAILED DESCRIPTION OF THE INVENTION

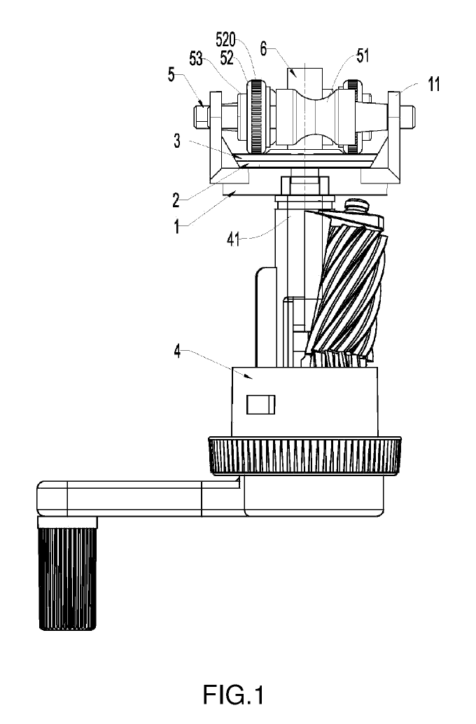

As shown in FIG. 1, an automatic pencil feeding device for a pencil sharpener comprises a support 1, a drive plate 2 and a turntable 3 which are fixed in the housing of the pencil holder. The drive plate 2 is centrally formed with a connecting hole 21 in which the tapered-hole end of a hollow pencil holder guide 41 of a hobbing head 4 is inserted.

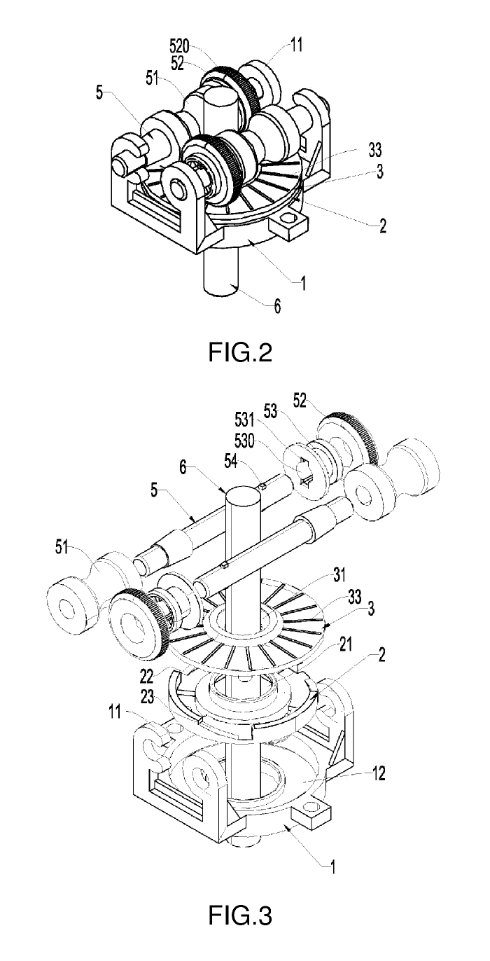

As shown in FIGS. 2, 3 and 4, the support 1 extends towards the same side to form two pairs of wheel-holding bearing blocks 11. Rotating shafts 5 capable of moving axially are respectively located on the two pairs of wheel-holding bearing blocks 11. A pencil-holding rotating wheel 51 and a friction wheel 52 are sleeved on each rotating shaft 5 in turn. Two friction wheels 52 are disposed at the far ends of the two rotating shafts 5. The turntable 3 is installed in the middle between the two pairs of wheel-holding bearing blocks 11, with surface toughing the two friction wheels 52. The support 1 and the turntable 3 are respectively centrally formed with a throughhole 31 through which the pencil holder passes. A sinking axle seat 12 is disposed at one side of the support 1 towards the turntable 3. The drive plate 2 is centrally placed in the sinking axle seat 12. The end face of the drive plate 2 is circumferentially formed with over two grooves 22 having sloping bottoms 23. Forks 32 corresponding in number to the grooves 22 of the drive plate are convexly disposed at one side of the turntable 3 adjacent to the turntable 2. The forks 32 are inserted into the grooves 22, forming a linkage between the drive plate 2 and the turntable 3.

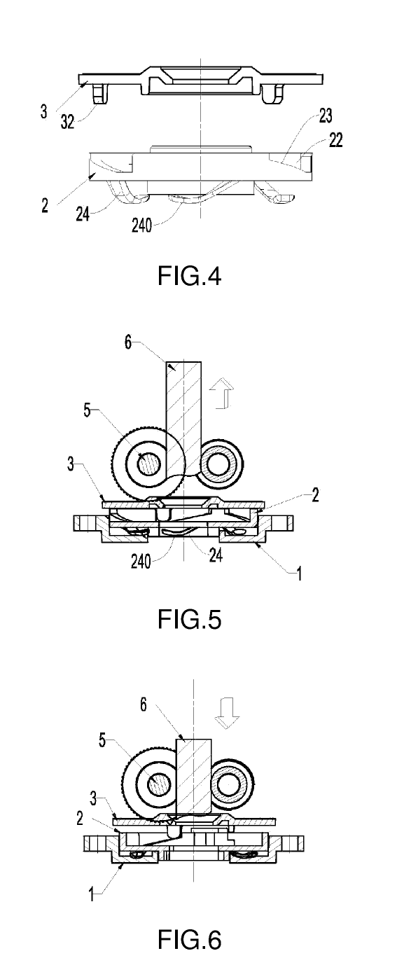

To expand the contact between the turntable 3 and the friction wheels 32, a spring is pivotally disposed between the drive plate 2 and the sinking axle seat 12. Or, as shown in FIG. 4, the end face of the drive plate 2 adjacent to the sinking axle seat 12 is provided with a reed 24 which is pressed against the sinking axle seat 12. The reed 24 and the drive plate 2 are integrally molded. The reed 24 has an arced end 240, preventing friction with the surface of the sinking axle seat 12 when the drive plate 2 rotates clockwise and anticlockwise and ensuring smooth rotation.

In addition, the surface of the turntable 3 is provided with radial friction patterns 33, and the surfaces of the friction wheels 52 are provided with fine, transverse patterns 520, thus improving the friction efficiency of the two. The friction wheels 52 are made of rubber materials through molding and sleeved on one running wheel 53 of which the axle hole 530 is formed with a pair of key grooves 531. Each rotating shaft 5 is convexly provided with two convex keys 54. The running wheels 53 are movably located on the rotating shafts 5 through the fit between the convex keys 54 and the key grooves 531. Moreover, when the pencil is fed by a certain journal, namely when the pencil holder sharpening is completed, the running wheels 53 can be separated from the rotating shafts 5. The pencil-holding rotating wheels 51 stop rotating and feeding the pencil.

FIG. 5 and FIG. 6 are sectional schematic views of pencil discharging and pencil feeding. FIG. 5 shows the pencil discharging state. The forks 32 of the turntable 3 slid to the bottoms of the grooves 22 of the drive plate 2. At this moment, the turntable 3 is slightly pressed against the friction wheels 52, and the operation of the pencil sharpener is relatively easy. FIG. 6 shows the pencil feeding state. The forks 32 of the turntable 3 moves upwards along the sloping bottoms 23 of the grooves 22, and then the turntable moves upward and is tightly pressed against the friction wheels 52, so slipping is prevented and the operation of the pencil sharpener is labor-consuming.

1. An automatic feeding device for a pencil sharpener, comprising a support and a turntable fixed in the housing of the pencil sharpener; the support extending towards the same side to form two pairs of wheel-holding bearing blocks, rotating shafts capable of moving axially being located on the two pairs of wheel bearing blocks respectively, and a pencil-holding rotating wheel and a friction wheel being sleeved on each rotating shaft in turn, with two friction wheels being located at the far ends of the two rotating shafts; the turntable being installed in the middle between the two wheel-holding bearing blocks and having surfaces capable of touching the two friction wheels, while the support and the turntable being centrally formed with a throughhole through which the pencil passes, characterized in that the side of the support towards the turntable is provided with a sinking axle seat; a drive plate is placed in the sinking axle seat; the drive plate is centrally formed with a connecting hole in which the tapered-hole end of a hollow pencil holder guide of a hobbing head is inserted; the end face of the drive plate is circumferentially formed with more than two grooves with sloping bottoms; one end face of the turntable adjacent to the drive plate is convexly provided with forks corresponding in number to the grooves of the drive plate; and the forks are inserted into the grooves, forming linkage between the drive plate and the turntable.

2. The automatic pencil feeding device for a pencil sharpener according to claim 1, characterized in that a spring is pivotally disposed between the drive plate and the sinking axle seat.

3. The automatic pencil feeding device for a pencil sharpener according to claim 1, characterized in that the end face of the drive plate adjacent to the sinking axle seat is provided with a reed, and the reed is pressed against the end face of the sinking axle seat.

4. The automatic pencil feeding device for a pencil sharpener according to claim 3, characterized in that the reed and the drive plate are integrally molded, and the reed has an arced end.

5. The automatic pencil feeding device for a pencil sharpener according to claim 1, characterized in that the surface of the turntable is provided with radial friction patterns, the surfaces of the friction wheels are provided with fine, transverse patterns.

6. The automatic pencil feeding device for a pencil sharpener according to claim 1, characterized in that each friction wheel is made from the rubber material through molding and sleeved on one running wheel of which the axle hole is formed with a pair of key grooves; each rotating shaft is convexly provided with two convex keys; and the running wheel is movably located on the rotating shaft through fit between the convex keys and the key grooves.

7. The automatic pencil feeding device for a pencil sharpener according to claim 5, characterized in that each friction wheel is made from the rubber material through molding and sleeved on one running wheel of which the axle hole is formed with a pair of key grooves; each rotating shaft is convexly provided with two convex keys; and the running wheel is movably located on the rotating shaft through fit between the convex keys and the key grooves.
